(19) United States
(12) Patent Application Publication
(10) Pub. No.: US 2017/0026604 A1
(43) Pub. Date: Jan. 26, 2017

(54) IMAGE SENSOR

(71) Applicant: Himax Imaging Limited, Tainan (TW)

(72) Inventors: Jia-Shyang Wang, Tainan (TW); Ching-Fong Chen, Tainan (TW)

(21) Appl. No.: 14/805,138

(22) Filed: Jul. 21, 2015

(51) Int. Cl. H04N 5/374; H04N 5/357; H04N 5/378

(52) U.S. Cl. CPC H04N 5/3741; H04N 5/378; H04N 5/3575

(57) ABSTRACT

An image sensor includes pixels arranged in 1×2 sharing manner by which two neighboring pixels of a same column form a pixel group. Two neighboring bit lines are connected to a multiplexer, and the output of the multiplexer is connected to a readout circuit. Neighboring transfer transistors of a same row are controlled by different transfer signals.

### BACKGROUND OF THE INVENTION

1. Field of the Invention

The present invention generally relates to an image sensor, and more particularly to a compact and low power image sensor with high conversion gain.

2. Description of Related Art

An image sensor, such as a complementary metal-oxide-semiconductor (CMOS) image sensor, is a device that converts an optical image into electronic signals. The image sensor has been widely used in a variety of applications such as cell phones and cameras.

As the resolution of the image sensor increases, more readout circuits are required to read out light signals from the pixels, and more power are thus consumed, resulting in more heat. There is a trend of the image sensor towards more compact circuit area by sharing circuits among multiple photodiodes. Although this scheme may substantially reduce circuit area, however, it causes lower conversion gain, and thus noise performance degradation.

A need has thus arisen to propose a novel image sensor with less circuit area and power consumption without sacrificing performance.

### SUMMARY OF THE INVENTION

In view of the foregoing, it is an object of the embodiment of the present invention to provide a compact and low power image sensor with high conversion gain and simple driver design. In one embodiment, pixels are arranged in 1×2 sharing manner. Two neighboring bit lines are connected to a multiplexer with an output connected to a readout circuit.

According to one embodiment, an image sensor includes a plurality of pixels, a plurality of multiplexers and a plurality of readout circuits. The pixels are arranged in 1×2 sharing manner by which two neighboring pixels of a same column form a pixel group. Two neighboring bit lines are connected to one of the multiplexers for selecting one of the two bit lines. Outputs of the multiplexers are connected to the readout circuits, respectively. Neighboring transfer transistors of a same row are controlled by different transfer signals.

### BRIEF DESCRIPTION OF THE DRAWINGS

FIG. 1 shows a block diagram of an image sensor;

FIG. 2A schematically shows a portion of the pixels arranged in non-sharing manner;

FIG. 2B shows pixel circuits of some of the pixels of FIG. 2A;

FIG. 3A schematically shows a portion of the pixels arranged in 2×1 sharing manner;

FIG. 3B shows pixel circuits of some of the pixels of FIG. 3A;

FIG. 4A schematically shows a portion of the pixels arranged in 2×2 sharing manner;

FIG. 4B shows pixel circuits of some of the pixels of FIG. 4A;

FIG. 5A schematically shows a portion of the pixels arranged in 1×2 sharing manner according to a first embodiment of the present invention;

FIG. 5B shows pixel circuits of some of the pixels of FIG. 5A;

FIG. 5C shows a timing diagram associated with FIG. 5B;

FIG. 6A schematically shows a portion of the pixels arranged in 1×2 sharing manner according to a second embodiment of the present invention;

FIG. 6B shows pixel circuits of some of the pixels of FIG. 6A; and

FIG. 6C shows a timing diagram associated with FIG. 6B.

### DETAILED DESCRIPTION OF THE INVENTION

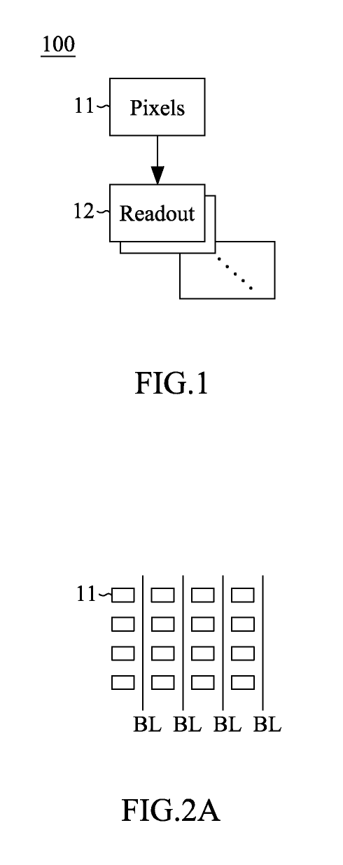

FIG. 1 shows a block diagram of an image sensor 100, such as a complementary metal-oxide-semiconductor (CMOS) image sensor. The image sensor 100 may primarily include pixels 11 arranged in rows and columns, and readout circuits 12 configured to read out light signals integrated (or accumulated) by the pixels 11.

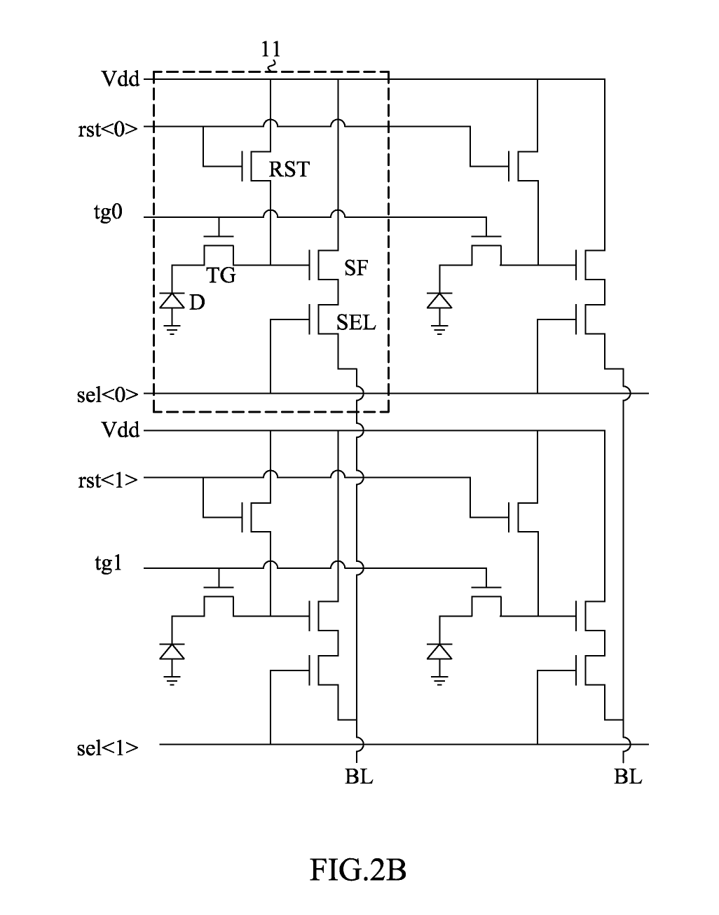

FIG. 2A schematically shows a portion of the pixels 11 arranged in non-sharing manner by which each pixel 11 may be independently operated, and FIG. 2B shows pixel circuits of some (e.g., four) of the pixels 11 of FIG. 2A. As shown in FIG. 2B, each pixel 11 includes a photodiode D, a reset transistor RST, a source follower transistor SF, a selector transistor SEL and a transfer transistor TG. When the reset transistor RST is turned on by a reset signal (e.g., rst<0>), the photodiode D is reset to a reference voltage such as a power supply Vdd. When the transfer transistor TG is turned on by a transfer signal (e.g., tg0), an integrated light signal of the photodiode D may then be transferred. The source follower transistor SF may be activated to buffer or amplify the integrated light signal of the photodiode D. When the selector transistor SEL is turned on by a select (or word line) signal (e.g., sel<0>), the integrated light signal may then be outputted via the selector transistor SEL. With respect to the architecture of FIG. 2A/2B, each bit line BL is connected to a corresponding readout circuit 12. As the readout circuit 12 occupies a substantive area, the pixel pitch of the image sensor 100 cannot be effectively reduced, and power consumption cannot be cut down.

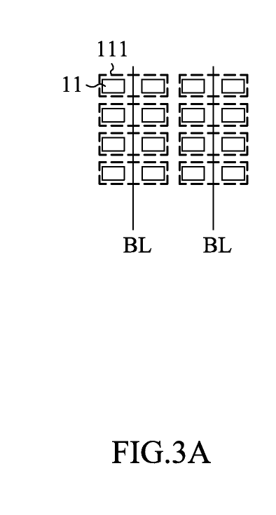

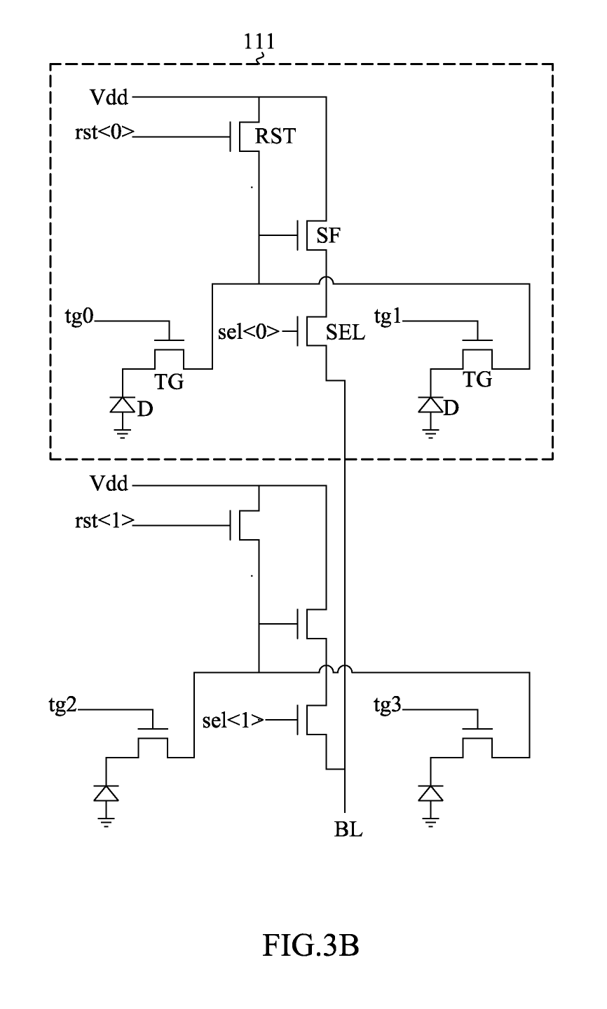

FIG. 3A schematically shows a portion of the pixels 11 arranged in 2×1 sharing manner by which two neighboring pixels 11 of the same row form a pixel group 111, and FIG. 3B shows pixel circuits of some (e.g., four) of the pixels 11 of FIG. 3A. As shown in FIG. 3B, a reset transistor RST, a source follower transistor SF, a selector transistor SEL are shared between two photodiodes D in the pixel group 111. With respect to the architecture of FIG. 3A/3B, neighboring pixel groups 111 use different reset signals rst<0> and rst<1>, and use different select signals sel<0> and sel<1>. Accordingly, a drive circuit (not shown) configured to generate the reset signals and the select signals cannot be reduced in complexity.

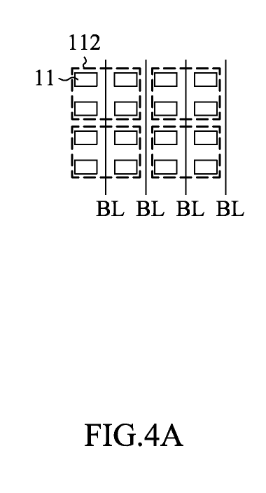

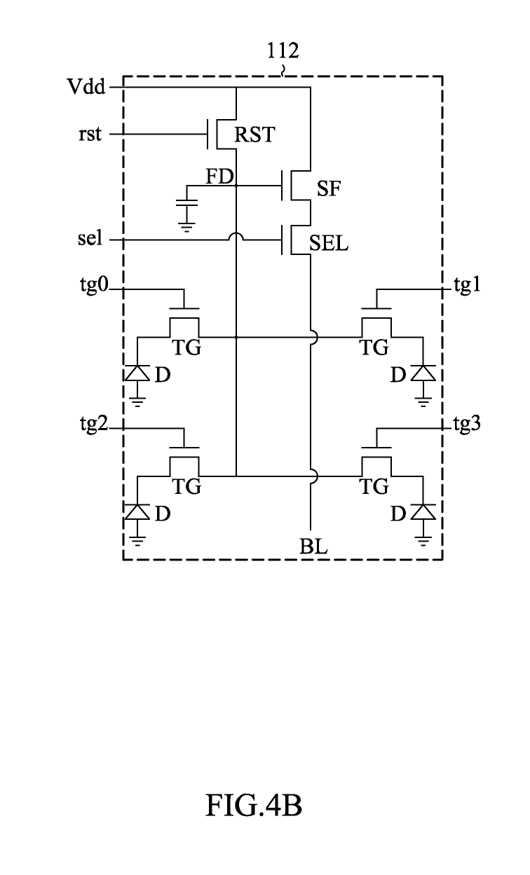

FIG. 4A schematically shows a portion of the pixels 11 arranged in 2×2 sharing manner by which four neighboring pixels 11 form a pixel group 112, and FIG. 4B shows pixel circuits of some (e.g., four) of the pixels 11 of FIG. 4A. As shown in FIG. 4B, a reset transistor RST, a source follower transistor SF, a selector transistor SEL are shared among four photodiodes D in the pixel group 112. Accordingly, floating diffusion capacitance FD is large, and conversion gain of the image sensor 100 is low.

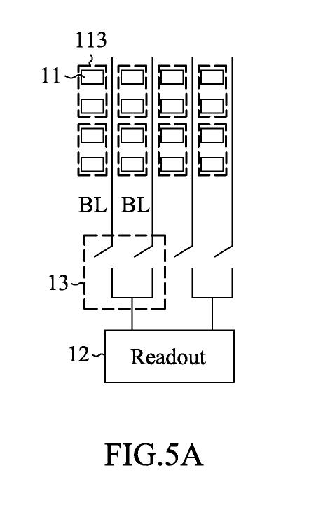

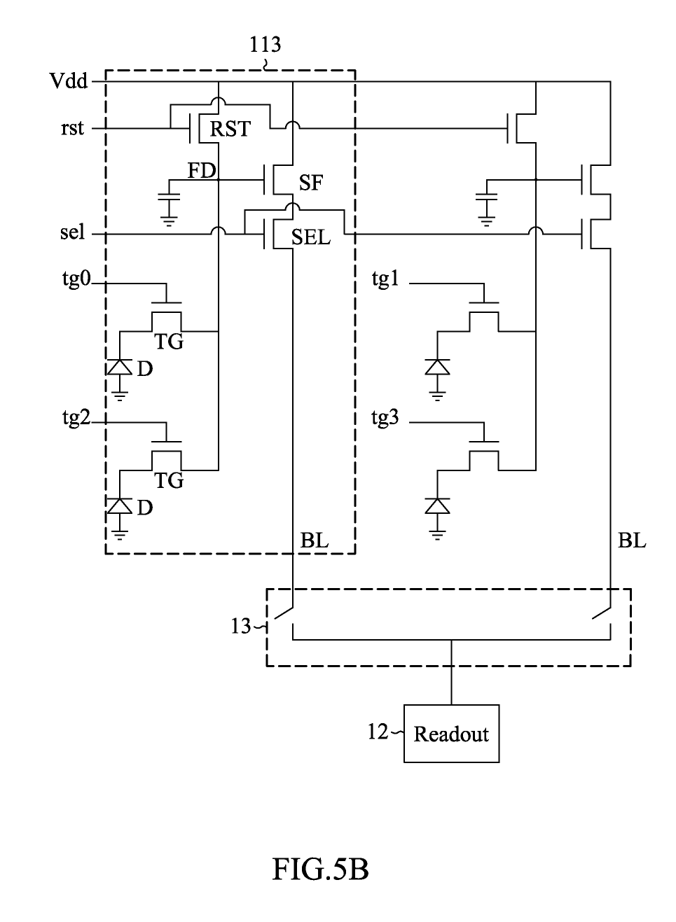

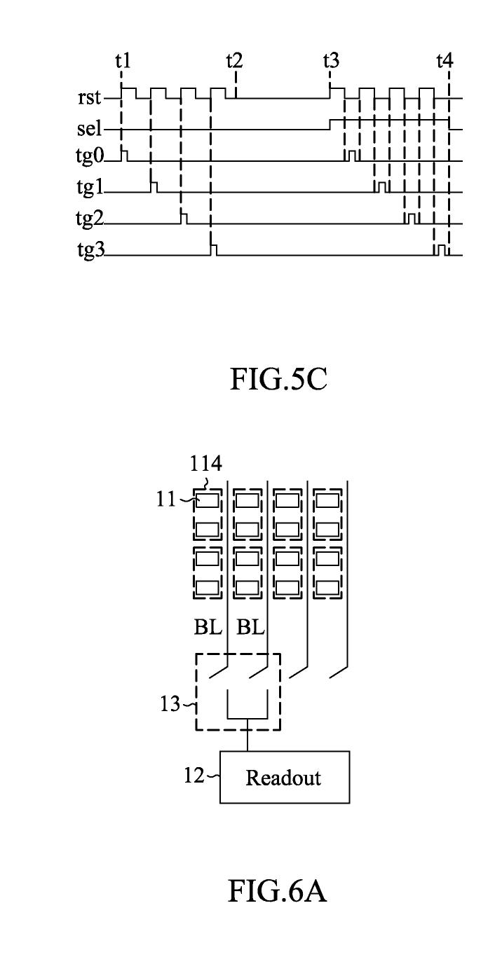

FIG. 5A schematically shows a portion of the pixels 11 arranged in 1×2 sharing manner by which two neighboring pixels 11 of the same column form a pixel group 113 according to a first embodiment of the present invention. FIG. 5B shows pixel circuits of some (e.g., four) of the pixels 11 of FIG. 5A. As shown in FIG. 5B, a reset transistor RST, a source follower transistor SF, and a selector transistor SEL are shared among two photodiodes D in the pixel group 113.

Specifically, a first terminal of the reset transistor RST is connected to a power supply Vdd, a second terminal of the reset transistor RST is connected to a floating diffusion point FD, and a control terminal of the reset transistor RST receives a reset signal rst. A first terminal of the source follower transistor SF is connected to the power supply Vdd, a second terminal of the source follower transistor SF is connected to a first terminal of the select transistor SEL, and a control terminal of the source follower transistor SF is connected to the floating diffusion point FD. A second terminal of the select transistor SEL acts as a bit line BL, and a control terminal of the select transistor SEL receives a select signal sel. Two terminals of each transfer transistor TG are respectively connected to the floating diffusion point FD and a corresponding photodiode D, and a control terminal of the transfer transistor TG receives a corresponding transfer signal tg.

Compared to FIG. 4B, as the pixel group 113 has less photodiodes D than the pixel group 112 in FIG. 4B, floating diffusion capacitance FD is smaller, and conversion gain of the image sensor 100 is higher. Compared to FIG. 3B, as neighboring pixel groups 113 use the same reset signal rst and the same select signal sel, a drive circuit (not shown) configured to generate the reset signal and the select signal becomes simpler.

According to one aspect of the embodiment, two neighboring bit lines BL are connected to a multiplexer 13 that selects one of the two bit lines BL at a time. An output of the multiplexer 13 is connected to a readout circuit 12. Compared to FIG. 2B, as fewer readout circuits 12 are used, substantial area can be saved, pixel pitch of the image sensor 100 can be effectively reduced, and power consumption can thus be cut down.

According to another aspect of the embodiment, neighboring transfer transistors TG of the same row are controlled by different transfer signals (e.g., tg0 and tg1).

FIG. 5C shows a timing diagram associated with FIG. 5B. From time t1 to time t2, the reset signal rst is asserted intermittently, and the four transfer signals tg0, tg1, tg2 and tg3 are asserted in sequence to perform pixel reset, respectively, followed by corresponding light signal integration. From time t3 to time t4, while the select signal sel is asserted, the reset signal rst is asserted intermittently to perform correlated double sampling (CDS) reset, and the four transfer signals tg0, tg1, tg2 and tg3 are asserted in sequence to perform correlated double sampling (CDS) readout, respectively, followed by corresponding light signal outputting.

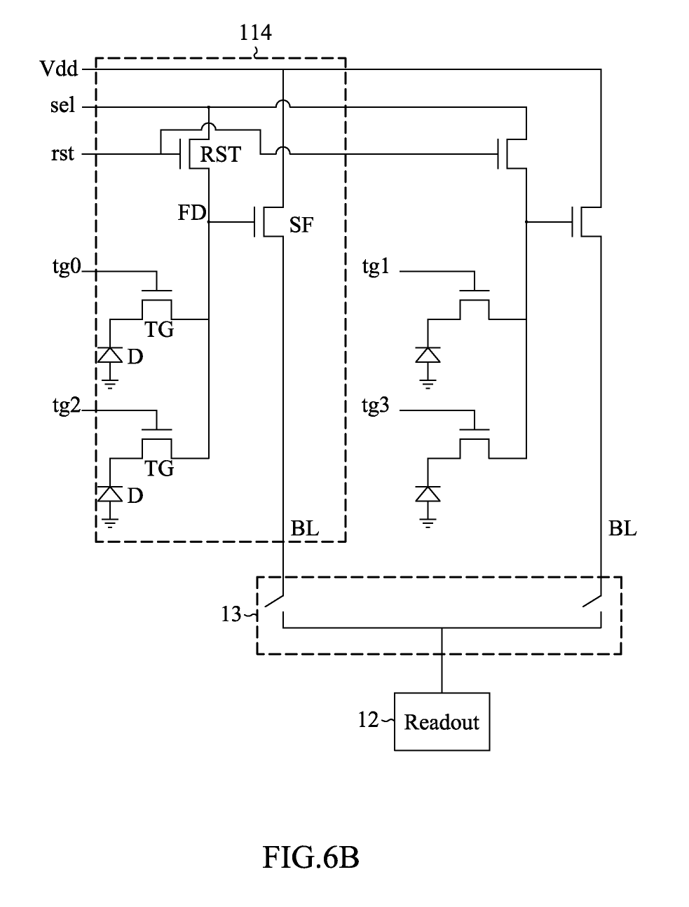

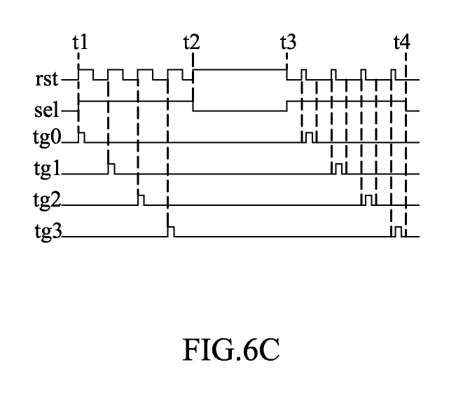

FIG. 6A schematically shows a portion of the pixels 11 arranged in 1×2 sharing manner by which two neighboring pixels 11 of the same column form a pixel group 114 according to a second embodiment of the present invention. FIG. 6B shows pixel circuits of some (e.g., four) of the pixels 11 of FIG. 6A. The second embodiment is similar to the first embodiment with the exception that no select transistor is required, thereby decreasing circuit area. As shown in FIG. 6B, a reset transistor RST and a source follower transistor SF are shared among two photodiodes D in the pixel group 114.

Specifically, a first terminal of the reset transistor RST is connected to the select signal sel, a second terminal of the reset transistor RST is connected to a floating diffusion point FD, and a control terminal of the reset transistor RST receives the reset signal rst. A first terminal of the source follower transistor SF is connected to a power supply Vdd, a second terminal of the source follower transistor SF acts as a bit line BL, and a control terminal of the source follower transistor SF is connected to the floating diffusion point FD. Two terminals of each transfer transistor TG are respectively connected to the floating diffusion point FD and a corresponding photodiode D, and a control terminal of the transfer transistor TG receives a corresponding transfer signal tg.

FIG. 6C shows a timing diagram associated with FIG. 6B. From time t1 to time t2, the select signal sel is asserted, that is, raised to a high level. The reset signal rst is asserted intermittently, and the four transfer signals tg0, tg1, tg2 and tg3 are asserted in sequence to perform pixel reset, respectively, followed by corresponding light signal integration. From time t3 to time t4, while the select signal sel is asserted, the reset signal rst is asserted intermittently to perform correlated double sampling (CDS) reset, and the four transfer signals tg0, tg1, tg2 and tg3 are asserted in sequence to perform correlated double sampling (CDS) readout, respectively, followed by corresponding light signal outputting.

Although specific embodiments have been illustrated and described, it will be appreciated by those skilled in the art that various modifications may be made without departing from the scope of the present invention, which is intended to be limited solely by the appended claims.

1. An image sensor, comprising:
a plurality of pixels arranged in 1×2 sharing manner by which two neighboring pixels of a same column form a pixel group;
a plurality of multiplexers, wherein two neighboring bit lines are connected to one of the multiplexers for selecting one of the two bit lines; and
a plurality of readout circuits, to which outputs of the plurality of multiplexers are connected, respectively;
wherein neighboring transfer transistors of a same row are controlled by different transfer signals, and neighboring transfer transistors of a same column are controlled by different transfer signals.

2. The image sensor of claim 1, wherein a reset transistor, a source follower transistor, and a selector transistor are shared among two photodiodes in the pixel group.

3. The image sensor of claim 2, with respect to the pixel group, a first terminal of the reset transistor is connected to a power supply, a second terminal of the reset transistor is connected to a floating diffusion point, and a control terminal of the reset transistor receives a reset signal; a first terminal of the source follower transistor is connected to the power supply, a second terminal of the source follower transistor is connected to a first terminal of the select transistor, and a control terminal of the source follower transistor is connected to the floating diffusion point; a second terminal of the select transistor acts as the bit line, and a control terminal of the select transistor receives a select signal; and two terminals of each transfer transistor are respectively connected to the floating diffusion point and a corresponding photodiode, and a control terminal of the transfer transistor receives a corresponding transfer signal.

4. The image sensor of claim 3, which performs the following steps:
from a first instance to a second instance, asserting the reset signal intermittently, and asserting four transfer signals in sequence to perform pixel reset, respectively, followed by corresponding light signal integration; and
from a third instance to a fourth instance, while the select signal is asserted, asserting the reset signal intermittently to perform correlated double sampling (CDS) reset, and asserting the four transfer signals in sequence to perform correlated double sampling (CDS) readout, respectively, followed by corresponding light signal outputting.

5. The image sensor of claim 1, wherein at least some of the plurality of pixels comprise no selector transistor.

6. The image sensor of claim 5, wherein a reset transistor and a source follower transistor are shared among two photodiodes in the pixel group.

7. The image sensor of claim 6, with respect to the pixel group, a first terminal of the reset transistor is connected to a select signal, a second terminal of the reset transistor is connected to a floating diffusion point, and a control terminal of the reset transistor receives a reset signal; a first terminal of the source follower transistor is connected to a power supply, a second terminal of the source follower transistor acts as the bit line, and a control terminal of the source follower transistor is connected to the floating diffusion point; and two terminals of each transfer transistor are respectively connected to the floating diffusion point and a corresponding photodiode, and a control terminal of the transfer transistor receives a corresponding transfer signal.

8. The image sensor of claim 7, which performs the following steps:
from a first instance to a second instance, asserting the select signal, asserting the reset signal intermittently, and asserting four transfer signals in sequence to perform pixel reset, respectively, followed by corresponding light signal integration; and
from a third instance to a fourth instance, while the select signal is asserted, asserting the reset signal intermittently to perform correlated double sampling (CDS) reset, and asserting the four transfer signals in sequence to perform correlated double sampling (CDS) readout, respectively, followed by corresponding light signal outputting.

9. The image sensor of claim 1 comprises a complementary metal-oxide-semiconductor (CMOS) image sensor.

10. The image sensor of claim 1, wherein the plurality of pixels are arranged in rows and columns.
